(19) United States
(12) Patent Application Publication
(10) Pub. No.: US 2022/0156861 A1
(43) Pub. Date: May 19, 2022

(54) SYSTEMS AND METHODS FOR BLOCKCHAIN-BASED DATA-DRIVEN PROPERTY MANAGEMENT

(71) Applicant: JPMORGAN CHASE BANK, N.A., New York, NY (US)

(72) Inventors: Bridget BRYNES, Broadview Heights, OH (US); Samuel YEN, Los Altos, CA (US); Octavio KEW, New Canaan, CT (US); Ken TSAI, Los Altos, CA (US); Arul NARAYANA, Cumming, GA (US)

(21) Appl. No.: 17/455,161

(22) Filed: Nov. 16, 2021

Related U.S. Application Data
(60) Provisional application No. 63/114,301, filed on Nov. 16, 2020.

(51) Int. Cl. G06Q 50/16; G06Q 10/06

(52) U.S. Cl. CPC G06Q 50/163; G06Q 10/0635

(57) ABSTRACT

Systems and methods for blockchain-based data-driven property management are disclosed. In one embodiment, a method for blockchain-based data-driven property management may include: (1) receiving, by a property management computer program, title information for a property from a title recordation office; (2) validating, by the property management computer program, the title information with an owner of the property, a lienholder of the property, and/or a recorder of the title information; (3) recording, by the property management computer program, the title information to a distributed ledger, wherein a consensus algorithm executing on nodes in a distributed ledger network update the distributed ledger with a block comprising the title information; (4) periodically polling, by a first smart contract, the title recordation office for updated title information for the property. (5) automatically notifying, by the first smart contract, an interested party of the updated title information.

### RELATED APPLICATIONS

This application claims priority to U.S. Provisional Patent Application Ser. No. 63/114,301, filed Nov. 16, 2020, the disclosure of which is hereby incorporated, by reference, in its entirety.

### BACKGROUND OF THE INVENTION

### 1. Field of the Invention

Embodiments are generally related to systems and methods for blockchain-based data-driven property management.

### 2. Description of the Related Art

The mortgage and origination and servicing process is reliant on data. Inconsistencies in data, however, results in errors. For example, multiple processes for an originator and/or lender are keyed off of the underlying property information. For a mortgage loan origination, the loan-to-value is a key aspect of the underwriting process and based on valuation (Appraisal), HUD-1 Settlement Statement or TRID (TILA RESPA Integrated Disclosures), underlying mortgage documentation, deed recording, and vesting. Servicing considers valuation, title, property preservation, default resolution group (curative title team), and the net present value model. Escrow management (tax and insurance), hazard insurance claim processing, and court jurisdiction (e.g., foreclosure, bankruptcy, litigation) may all rely on this data.

### SUMMARY OF THE INVENTION

Systems and methods for blockchain-based data-driven property management are disclosed. In one embodiment, a method for blockchain-based data-driven property management may include: (1) receiving, by a property management computer program, title information for a property from a title recordation office; (2) validating, by the property management computer program, the title information with an owner of the property, a lienholder of the property, and/or a recorder of the title information; (3) recording, by the property management computer program, the title information to a distributed ledger, wherein a consensus algorithm executing on nodes in a distributed ledger network update the distributed ledger with a block comprising the title information; (4) periodically polling, by a first smart contract, the title recordation office for updated title information for the property. (5) automatically notifying, by the first smart contract, an interested party of the updated title information.

In one embodiment, the method may further include monitoring, by a second smart contract, the distributed ledger for a subsequent entry associated with the property; and automatically notifying, by the second smart contract, the interested party of the subsequent entry.

In one embodiment, the subsequent entry may include an event that impacts the title to the property, such as a sale of the property, a lien on the property, a release of the lien on the property, etc.

In one embodiment, the method may further include monitoring, by a third smart contract, online resources for a title event for the property. The title event may include a sale of the property, a lien on the property, a release of the lien on the property, etc.

According to another embodiment, a method for distributed ledger-based property valuation may include: (1) retrieving, by a property valuation computer program, income data and operating expense data for a property; (2) determining, by the property valuation computer program, a net operating income for the property based on the income data and the operating expense data; (3) determining, by the property valuation computer program, a market potential and an economic outlook for the property; (4) building, by the property valuation computer program, a property valuation model for the property; (5) forecasting, by the property valuation computer program, a forecasted property value for the property; and (6) adjusting, by the property valuation computer program, the property valuation model based on a difference between the forecasted property value and an actual property value.

In one embodiment, the income data and/or the operating expense data may be received from a distributed ledger, from a bank account, from a tax filing, etc.

In one embodiment, the method may further include forecasting, by the property valuation computer program, rental income for the property based on historical rent for the property and a property characteristic for the property.

In one embodiment, the computer program may forecast the rental income using a time series model and time independent model.

In one embodiment, the property valuation computer program may forecast the rental income using a market potential for the property.

In one embodiment, the property valuation computer program may forecast the rental income using an economic outlook for the property.

According to another embodiment, a method for targeting a property using a distributed ledger network may include: (1) identifying, by a targeting computer program, a property recorded on a distributed ledger; (2) retrieving, by the targeting computer program, title information for the identified property from the distributed ledger; (3) retrieving, by the targeting computer program, a property specific for the property; (4) applying, by the targeting computer program, a targeting criteria to the property specific; and (5) targeting, by the targeting computer program, an owner of the property.

In one embodiment, the targeting criteria may be based on a net operating income for the property.

In one embodiment, the net operating income for the property may be based on income data and operating expense data for a property, wherein the income data and/or the operating expense data may be retrieved from a distributed ledger, from a bank account, from a tax filing, etc.

In one embodiment, the property specific may include a property size and/or a property location.

In one embodiment, the step of targeting the owner of the property may include sending a communication to the owner of the property.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for blockchain-based data-driven property management according to an embodiment;

FIG. 2 depicts a method for blockchain-based data-driven property valuation according to an embodiment;

FIG. 3 depicts a method for property valuation according to an embodiment;

FIG. 4 depicts a method for blockchain-based data-driven property management according to an embodiment;

FIG. 5 depicts a method for targeting a property using a distributed ledger network according to an embodiment;

FIG. 6 depicts a method for a method for tenant behavior and property health monitoring according to an embodiment.

### DETAILED DESCRIPTION OF PREFERRED EMBODIMENTS

Embodiments are generally related to systems and methods for blockchain-based data-driven property valuation. Although embodiments may be disclosed in the context of real estate (both personal and commercial), it should be recognized that the embodiments may have applicability with other properties, including, for example, automobiles, mobile homes, vehicles, etc.

Embodiments may leverage the distributed ledger network to identify money laundering and fraud. For example, bad actors (e.g., realtors, closing agents, appraisers, inspectors, etc.) may be identified from prior transactions that are written to the distributed ledger. Examples may include trends identifying the use of inaccurate comparable sales, inaccurate appraisals, a company, judge, or court that affects timelines or outcomes (e.g., always ruling one way), etc. may be used to identify bad actors.

In one embodiment, money laundering may be identified from, for example, reliance on a LLC to hide transactions, etc.

Embodiments may use additional contextual data such as geocode of location and mobile device ID, network connectivity ID, email ID of participants in the loan origination and lending process to enhance the verification process. In embodiments, a property location, property type, property rights, property project, property specifics, location mapping, etc. may be used to identify a property and may be written to a distributed ledger.

The property location may be based on a geolocation. It may include a specific property address, legal description, property type, tax assessor parcel, latitude/longitude, census track, condo/co-op/PUD, homeowner's association or co-op board, neighborhood, township, city, county, state, MSA, etc.

The property type may be defined and entered into the system of record at origination. The property type is an important field to track its data lineage because it may affect valuation and underlying liquidity of the mortgage loan. An illegal conversion of a property (e.g., a single-family residence being converted to a day care center) is a non-monetary default on the mortgage loan. Co-ops require a different foreclosure process than other property types. Embodiments may use a consistent property type, and if there is a change, the change is written to the distributed ledger. Additionally, embodiments may add digital agents to perform detect and notify function in the blockchain network to monitor both the change history and where-use of property type data.

Embodiments may capture special access method and history to the property to provide visibility on method of gaining entry, its change history. For example, at origination, access is defined if property is gated, in a high-rise building or requires special access (e.g., by boat). If special access to the property is needed, information related to the homeowner's information or property management company may be captured and shared with whomever requesting the special access. As an exemplary use case, if the property goes into default, the lender orders updated valuations and property inspections. If a property is subject to a natural disaster, lender orders a property inspection report. To perform the inspections, the lender needs access to the property or it needs to know that it cannot gain access.

Embodiments may capture certain property rights (e.g., fee simple versus leasehold). At origination, the property rights flag is confirmed to be accurate. If a unit (condo/co-op, etc.) is in a building with a ground lease, that the terms of the lease and expiration date of the lease are captured.

Embodiments may capture a property project, if applicable. For example, property projects for condo and co-ops, including financial and other details on the underwrite of the project (e.g., number of units in the project) may be written to the distributed ledger. Other information, such as project Name, HOA and/or property management contact information may be written to the distributed ledger. As this information is updated or changes, all units/loans linked to the building will go through a digital co-verification and governance process to have their information updated.

Embodiments may capture property specific properties. Examples include building information (e.g., bed count, bath count, half bath count, floors, general living area (GLA), property style, property construction type, builder, etc.), extras (e.g., additional buildings, pool, tennis courts, garage, basement, fireplace, elevator, boat dock, etc.), view (e.g., waterfront), features (e.g., septic, well, site, dimensions, site area, specific zoning classification and description, zoning compliance, drainage, driveway surface, apparent easements, FEMA flood detail, etc. The information may be captured and written to the distributed ledger.

Embodiments may collect location mapping, including county recording office, tax assessment, real estate transaction costs (e.g., transfer taxes, real estate transaction, weather, deficiency judgments, vacant property registration, building code and building code enforcement, government programs (e.g., USDA eligibility, FHA/VA limits, FHFA eligibility, Community Redevelopment Act, Section 8 Housing, FEMA disaster declarations), court system (e.g., litigation, foreclosure, bankruptcy, court mandated meditation, housing court, eviction, court of appeals), flood zone, fire zone, etc.

In embodiments, the HUD-1 Statement may be included. The HUD-1 illustrates the flow of funds in a real estate transaction. It also shows the fees that were paid, e.g., real estate commissions, attorney fees, etc.

In the origination appraisal process, the base property data may be used to ensure that the correct location and property components are considered, and that the legal description of the property matches the public record and title.

In one embodiment, fraud and/or money laundering may be identified based on data written to the distributed ledger. For example, a smart contract may monitor the distributed ledger for suspicious activities that may be indicative of fraud and/or money laundering. If an individual has a history of fraudulent activity, transactions associated with that individual may be flagged as potentially fraudulent.

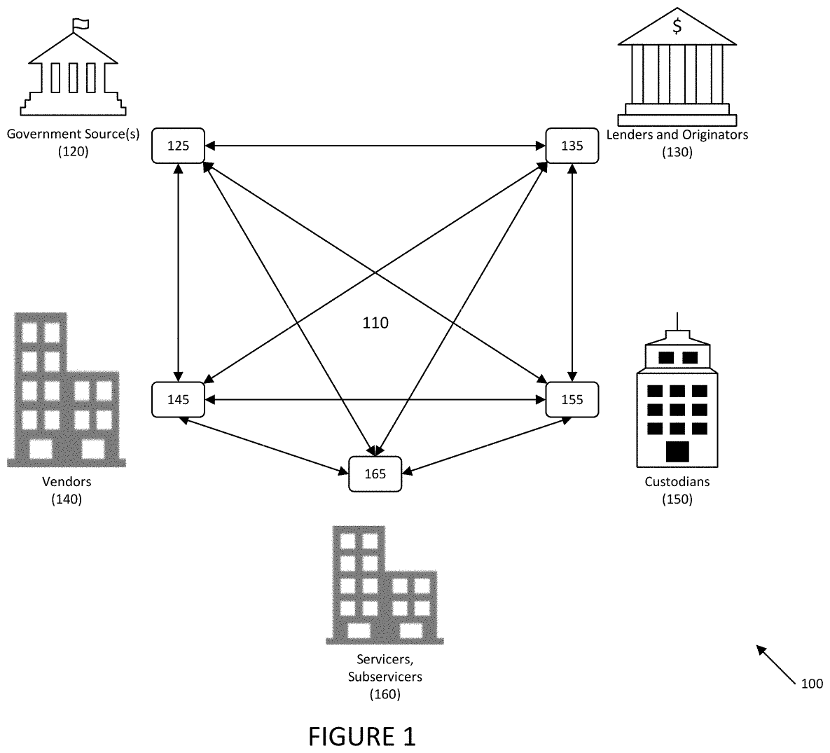

Referring to FIG. 1, a system for blockchain-based data-driven property management is disclosed according to one embodiment. System 100 may include distributed ledger network 110 that may include a plurality of sources, such as government source(s) 120, lender and originators 130, vendor(s) 140, custodian 150, and servicers/subservicers 150. Other types of sources may be used as is necessary and/or desired.

Examples of lender and originators 130 may closing agents, real estate agents, title insurance companies, mortgage origination companies (e.g., loan officer, retail location, valuation reviewer, exception approval (i.e., who gave authorization)), property inspectors, appraisers, AWM providers, condo/co-op organizations, attorneys for buyers and sellers, etc.

Examples of servicers/subservicers 150 may include authorized third parties (e.g., realtors, loss mitigation companies and authorized representatives, law offices and respective attorneys, relatives, etc.), title vendors, property preservation vendors (e.g., property inspectors/vendors, construction vendors; foreclosure parties, bankruptcy parties, valuation companies, appraisers, insurance vendors, loan integrity offices, etc.).

Each source 120, 130, 140, 150, and 160 may maintain a copy of a distributed ledger, such as copies 125, 135, 145, 155, and 165. Alternately, one or more source 120, 130, 140, 150, and 160 may access distributed ledger network using an API.

Distributed ledger network 110 may provide an immutable record of transactions. In embodiments, the distributed ledgers may be based on distributed ledger/blockchain technology. In embodiments, a consensus algorithm operating on nodes for sources 120, 130, 140, 150, and 160 may update the distributed ledger copies 125, 135, 145, 155, and 165. Information may be added to a block on copies 125, 135, 145, 155, and 165 in the blockchain-based system according to the consensus algorithm.

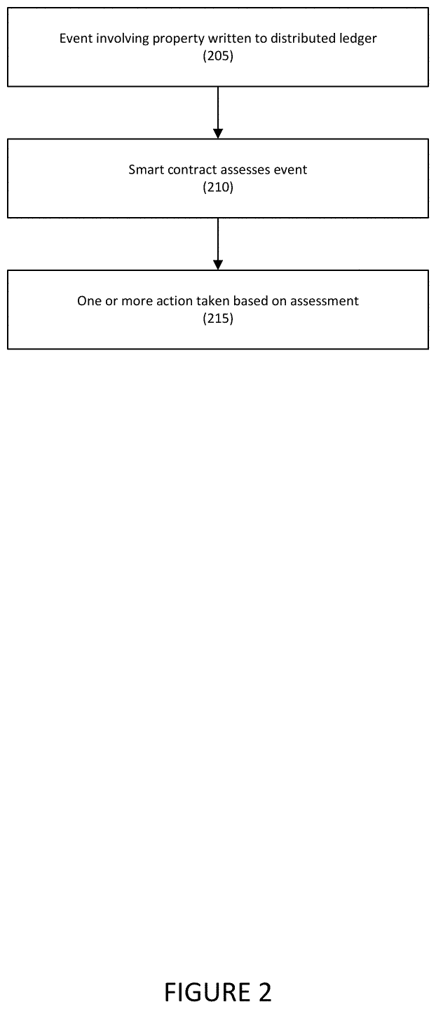

Referring to FIG. 2, a method for blockchain-based data-driven property management is provided according to one embodiment.

In step 205, an event involving a property may be written to a distributed ledger. For example, a lender or loan originator, servicers, a government agency, a vendor, a custodian, or any other suitable entity may write an activity involving a property to the distributed ledger. Examples may include a sale of the property, a deed, a title policy, a tax record, an appraisal, a covenant, an assessment, damage, improvements, etc. Any suitable event may be written as is necessary and/or desired.

In one embodiment, the event may be written by a participant of the distributed ledger network as a block on the disturbed ledger. In one embodiment, a consensus algorithm executed on the nodes of the distributed ledger may add the block to each node's copy of the distributed ledger.

In one embodiment, submissions regarding surrounding areas, properties, etc. may be recorded as is necessary and/or desired.

In step 210, a smart contact may assess the event. For example, the smart contact may execute one or more algorithm to interpret the event. In one embodiment, the algorithm may determine a value of the property based on the content of the distributed ledger.

In step 215, an action may be taken based on the assessment. For example, the long-term value of a property may be reassessed based on the information written to the distributed ledger. As another example, risk algorithms may be configured to consider information on the distributed ledger. Other actions, such as informing authorities regarding fraud or money laundering, providing personalized, subscription-based notifications from network participants on key events and data change concerning a property, etc. may be taken as is necessary and/or desired.

In one embodiment, the property may be valued based on the net operating income for the property (e.g., rent rolls minus expenses).

In one embodiment, machine learning algorithms may be used to valuate a property. For example, machine learning algorithms may learn from appraiser historical data, rent rolls, operating expenses, etc. Data sources may include on-chain sources, off-chain sources (e.g., tax records, banking accounts, third-party accounts (e.g., utilities), etc.), etc. A risk model may be built considering socioeconomic factors, such as inflation, deflation, economic outlook, market forecasting, etc. to correct/adjust the model valuation predicting short-term and long-term potentiation (value). The machine learning model may be segmented, mostly by markets and in some cases at sub-market level, in order to customize the weights associated with input attributes to such markets (for example, a high weightage for location proximity at New York model may not necessarily be true elsewhere). The models may be re-tuned in service such that they continuously learn from actual valuation to adjust their weights across various factors that influence the property valuation. At the same time, the models may be capable of identifying any net new factor that was not part of the models and thus alerting the models to be re-built in due course.

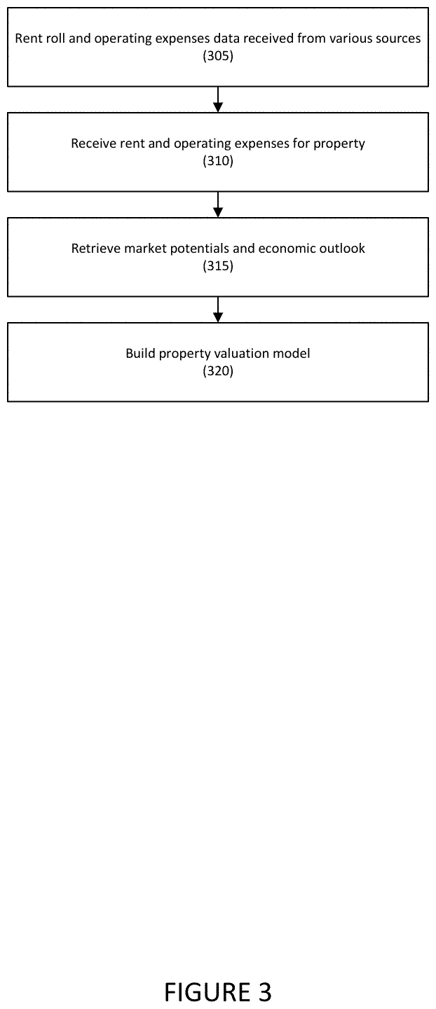

Referring to FIG. 3, a method for property valuation is provided according to an embodiment. In step 305, income (e.g., rent roll) and operating expenses data may be retrieved from various sources. For example, as discussed above, income and expense data may be retrieved from one or more distributed ledgers, off-chain sources (e.g., tax records, banking accounts, etc.).

In step 310, the net operating income for the property may be determined. In step 315, market potentials and economic outlook for the property may be retrieved. Market potential is an augmented index derived from metrics such as population (density), industry, school zone, government infrastructure products, etc. This information may be available from government and third-party sources.

Economic outlook may be related to industry trends and job/salary prospects, spending behavior, etc.

In step 320, one or more property valuation models may be built and tuned to continuously adjust for actual values.

In embodiments, rental forecasting may consider modeling several influencing factors such as historical rent, property characteristics (e.g., square feet, amenities, location, etc.). Such models may be hybrid models that leverage the past values of input variables (e.g., population density.), using time series models, such as Autoregressive Integrated Moving Average (ARIMA) and time independent models (e.g., deep learning models) to leverage the input variables (e.g., unit size) that are not time dependent. The time series learning may be adjusted against time independent influence in order to forecast rental values. Model performance may be continuously evaluated and retrained for improved accuracy.

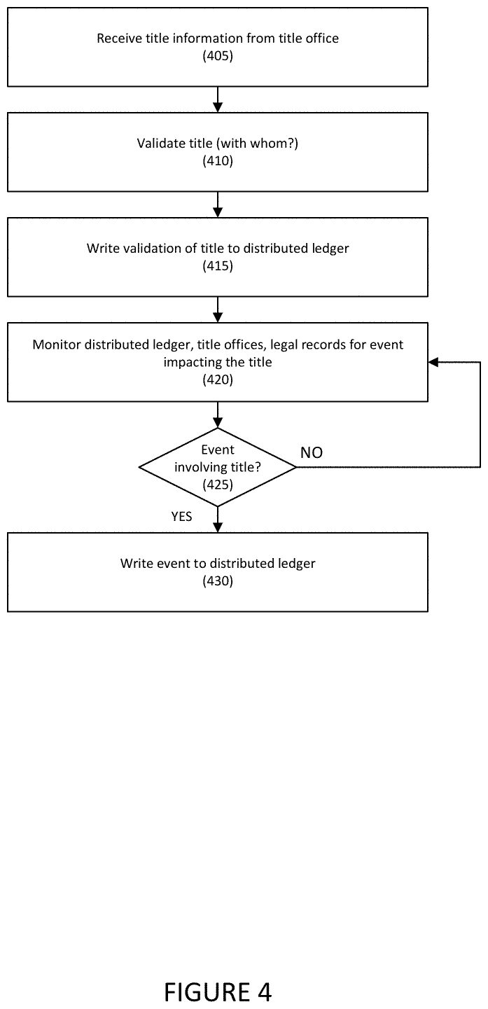

FIG. 4 depicts a method for blockchain-based data-driven property management is provided according to one embodiment.

In step 405, a property management computer program may receive title information from title office or similar source.

In step 410, the property management computer program may validate the title information with the property owner, a lienholder, the recorder of deeds, etc.

In step 415, the property management computer program may write the title validation to the distributed ledger.

In step 420, a smart contract may monitor the distributed ledger for entries involving the property. For example, it may monitor for any event that may impact the title, such as sales, liens, releases, etc. Embodiments may further monitor third party data sources (e.g., legal publications, notices, etc.) for events. In one embodiment, a smart contract may perform the monitoring.

In one embodiment, the property management computer program may periodically poll the source of title information for any events involving the title. It may further review on-line legal notices for any events involving the title. In one embodiment, a smart contract may perform the polling.

In step 425, if there is an event involving the title, in step 430, the property management computer program may write the event to the distributed ledger.

Embodiments may further send notification to network participants that are interested in or impacted by the event. In embodiments, a trained machine learning model may be used to discern true valuable signals from noises.

If there is not an event involving the title, the smart contract may continue to monitor the information sources for events involving the title.

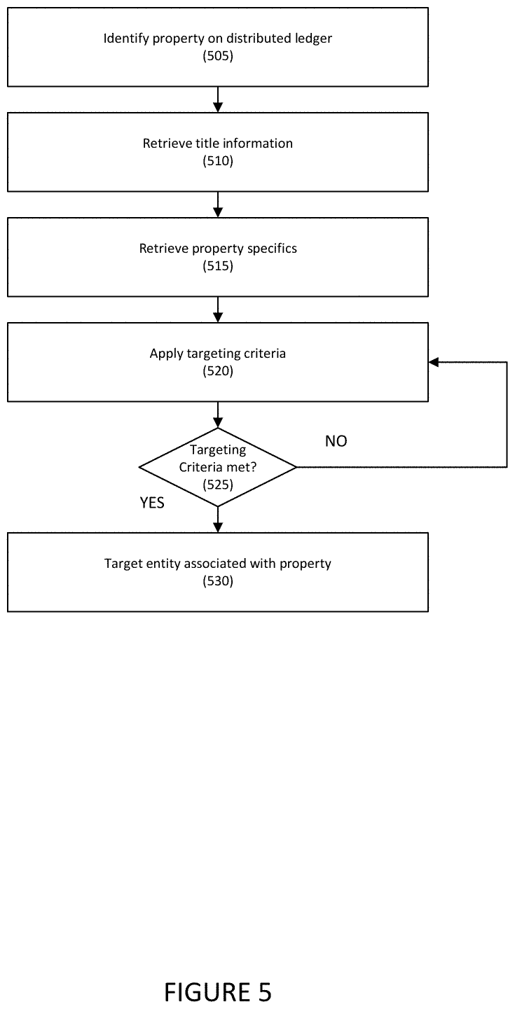

Referring to FIG. 5, an exemplary method of a targeting a property using a distributed ledger network is disclosed according to an embodiment.

In step 505, a computer program, such a targeting computer program executed by a participant in a distributed ledger network, may identify one or more properties recorded on a distributed ledger. In one embodiment, the computer program may identify properties according to one or more criteria, such as property value, value of liens, type of liens, location, type of property, etc.

In embodiments, trained machine learning models may be used to discern signals that lead to increased propensity for a loan, such as payoff of property improvement loans, duration of loan, etc. from other signals.

In step 510, the computer program may retrieve title information for the identified properties from the distributed ledger. Examples may include the property ownership structure, contact information, rental income history, expense history, prior sales data, etc.

In step 515, the computer program may retrieve property specifics for the property from off-chain sources.

In step 520, the computer program may apply targeting criteria to the retrieved title information and/or property information. For example, the targeting criteria may be based on one or more of a property values, a value of any liens on the property, a location for the property, an owner of the property, a property type (e.g., class A, B, C), rental income, expense history, mortgage history, combinations thereof, etc.

In one embodiment, the targeting criteria may have one of ore thresholds, such as a dollar amount. In one embodiment, the thresholds may be determined using a trained machine learning algorithm that may be based on results of historical targeting attempts.

If, in step 525, the targeting criteria is met, in step 530, the computer program may target the owner or entity associated with the property. In embodiments, once the targeted segment profile (e.g., demographic, job, age of property owner who are ideal customer) is identified, a look-alike model may be built to discover the same audience segment in different regions.

In one embodiment, the interest in a property may be tokenized. For example, one or more tokens representing interest in a title to a property may be generated, and may be written to a distributed ledger. The tokens or parts of the tokens may be sold or exchanged, or used for collateral, by writing a status of the token on the distributed ledger.

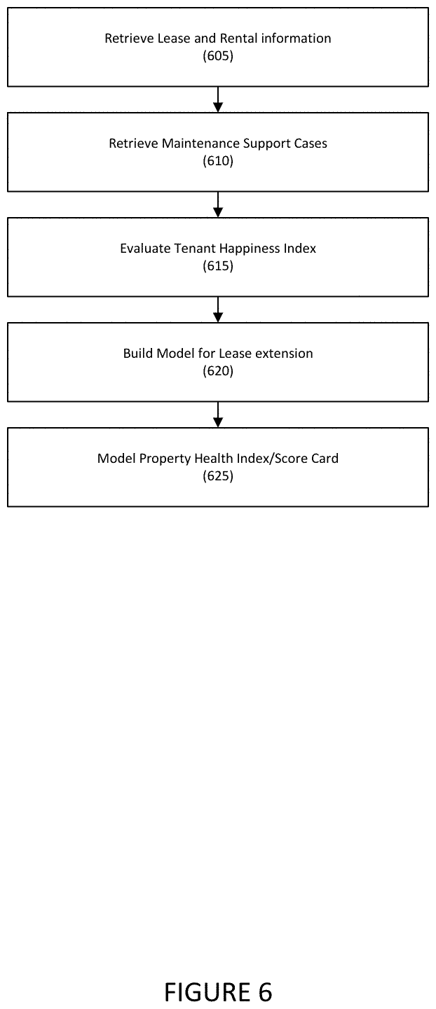

Referring to FIG. 6, a method for tenant behavior and property health monitoring is disclosed according to an embodiment.

In step 605, lease and rental information may be retrieved from, for example, on-chain sources, off-chain sources, etc.

In step 610, maintenance support cases may be retrieved. In one embodiment, the support cases may be retrieved from a database, from an external source (e.g., a maintenance provider, an insurance provider, etc.). The support cases may include time to resolve the support case, severity, tenant impact as a result of the event, etc.

In step 615, a tenant happiness index may be generated and evaluated. For example, the tenant happiness index may be based on a frequency/volume of tenant support cases, the case closure time versus the service legal agreement, communications from/to the tenant (e.g., sentiment extracted using natural language processing), a behavior analysis of the tenant, and a crowded analysis. Some or all of these inputs may be provided model that may quantify the tenant happiness by weighting each factor individually and combining the factors using a weighting scheme.

In step 620, a model for lease extension may be built. In one embodiment, based on the tenant happiness index, a trained machine learning engine may predict a rate and/or a length for a lease extension.

In step 625, a property health index model or score card may be generated. In embodiments, the property health model may be based on property conditions, tenant happiness, etc.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for blockchain-based data-driven property management, comprising:
receiving, by a property management computer program, title information for a property from a title recordation office;
validating, by the property management computer program, the title information with an owner of the property, a lienholder of the property, and/or a recorder of the title information;
recording, by the property management computer program, the title information to a distributed ledger, wherein a consensus algorithm executing on nodes in a distributed ledger network update the distributed ledger with a block comprising the title information;
periodically polling, by a first smart contract, the title recordation office for updated title information for the property; and
automatically notifying, by the first smart contract, an interested party of the updated title information.

2. The method of claim 1, further comprising:
monitoring, by a second smart contract, the distributed ledger for a subsequent entry associated with the property; and
automatically notifying, by the second smart contract, the interested party of the subsequent entry.

3. The method of claim 2, wherein the subsequent entry comprises an event that impacts the title to the property.

4. The method of claim 3, wherein the event comprises a sale of the property, a lien on the property, and/or a release of the lien on the property.

5. The method of claim 1, further comprising:
monitoring, by a third smart contract, online resources for a title event for the property.

6. The method of claim 5, wherein the title event comprises a sale of the property, a lien on the property, and/or a release of the lien on the property.

7. A method for distributed ledger-based property valuation, comprising:
retrieving, by a property valuation computer program, income data and operating expense data for a property;
determining, by the property valuation computer program, a net operating income for the property based on the income data and the operating expense data;
determining, by the property valuation computer program, a market potential and an economic outlook for the property;
building, by the property valuation computer program, a property valuation model for the property;
forecasting, by the property valuation computer program, a forecasted property value for the property; and
adjusting, by the property valuation computer program, the property valuation model based on a difference between the forecasted property value and an actual property value.

8. The method of claim 7, wherein the income data and/or the operating expense data is received from a distributed ledger.

9. The method of claim 7, wherein the income data and/or the operating expense data is received from a bank account.

10. The method of claim 7, wherein the income data and/or the operating expense data is received from a tax filing.

11. The method of claim 7, further comprising:
forecasting, by the property valuation computer program, rental income for the property based on historical rent for the property and a property characteristic for the property.

12. The method of claim 11, wherein the property valuation computer program forecasts the rental income using a time series model and a time independent model.

13. The method of claim 11, wherein the property valuation computer program forecasts the rental income using a market potential for the property.

14. The method of claim 11, wherein the property valuation computer program forecasts the rental income using an economic outlook for the property.

15. A method for targeting a property using a distributed ledger network, comprising:
identifying, by a targeting computer program, a property recorded on a distributed ledger;
retrieving, by the targeting computer program, title information for the identified property from the distributed ledger;
retrieving, by the targeting computer program, a property specific for the property;
applying, by the targeting computer program, a targeting criteria to the property specific; and
targeting, by the targeting computer program, an owner of the property.

16. The method of claim 15, wherein the targeting criteria is based on a net operating income for the property.

17. The method of claim 16, wherein the net operating income for the property is based on income data and operating expense data for a property, wherein the income data and/or the operating expense data are retrieved from a distributed ledger.

18. The method of claim 16, wherein the net operating income for the property is based on income data and operating expense data for a property, wherein the income data and/or the operating expense data are retrieved from a bank account or a tax filing.

19. The method of claim 15, wherein the property specific comprises a property size and/or a property location.

20. The method of claim 15, wherein the step of targeting the owner of the property comprises sending a communication to the owner of the property.
